(19) United States
(12) Patent Application Publication
(10) Pub. No.: US 2018/0373552 A1
(43) Pub. Date: Dec. 27, 2018

(54) CONSISTENT VIRTUAL MACHINE PERFORMANCE ACROSS DISPARATE PHYSICAL SERVERS

(71) Applicant: MICROSOFT TECHNOLOGY LICENSING, LLC, REDMOND, WA (US)

(72) Inventors: Francis Manoj DAVID, Bellevue, WA (US); Yimin DENG, Redmond, WA (US); Melur Krishnamurthy RAGHURAMAN, Sammamish, WA (US)

(21) Appl. No.: 15/633,452

(22) Filed: Jun. 26, 2017

(51) Int. Cl. G06F 9/455; H04L 12/911; H04L 29/08

(52) U.S. Cl. CPC G06F 9/45558; H04L 47/82; G06F 2009/45562; G06F 2009/45595; G06F 2009/4557; H04L 67/30

(57) ABSTRACT

Embodiments are directed to ensuring that VM behavior and characteristics are maintained as datacenter hardware changes and tenant VMs are migrated to newer hardware. Virtual machine resources are modeled and constraints defined on individual resources for each generation of physical server hardware. Constraints may be expressed as absolute limits (e.g., memory size), as some fraction of the physical resource (e.g., a percentage of the physical processor performance), or in terms of a behavior profile (e.g., performance variations with usage patterns, such as a disk drive behavior profile). When appropriately modeled, performance can be normalized across different server hardware generations and the cloud service provider can deploy the same virtual machine on different hardware.

### BACKGROUND

Cloud service providers sell virtual machines (VMs) that have specific performance and behavioral characteristics, such as particular processor, memory, disk, or network capabilities. The configurations of the VMs have much longer lifetime than the underlying physical servers upon which they are hosted. A specific VM configuration must be supported when the underlying hardware is replaced or when newer generations of hardware is available. The new hardware may provide a faster processor, disk, or network that was not contemplated in the original VM configuration.

Moving a tenant's VMs to new hardware can effectively give the tenant a free upgrade. However, the free upgrade may be a problem if a tenant's application that it is designed for the original VM is not compatible with the free upgrade. For example, the tenant's application may behave in unexpected ways if the new hardware has significant changes in processor, memory, disk, or network capabilities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a datacenter service provider ensures that VM behavior and characteristics are maintained as datacenter hardware changes and tenant VMs are migrated to newer hardware. This ensures that the tenant's applications are running on known hardware capabilities and prevents the applications from operating in unexpected ways following a VM migration.

Virtual machine resources are modeled and constraints defined on individual resources for each generation of physical server hardware. Constraints may be expressed as absolute limits (e.g., memory size), as some fraction of the physical resource (e.g., a percentage of the physical processor performance), or in terms of a behavior profile (e.g., performance variations with usage patterns, such as a disk drive behavior profile). When appropriately modeled, performance can be normalized across different server hardware generations and the cloud service provider can deploy the same virtual machine on different hardware.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a distributed computing network that provides cloud computing services according to one embodiment.

FIG. 2 is a block diagram illustrating one embodiment for shaping the behavior of VMs to keep them consistent across various hardware generations.

FIG. 3 illustrates a computer-implemented method for configuring virtual machines according to one embodiment.

FIG. 4 illustrates a computer-implemented method for configuring virtual machines according to another embodiment.

### DETAILED DESCRIPTION

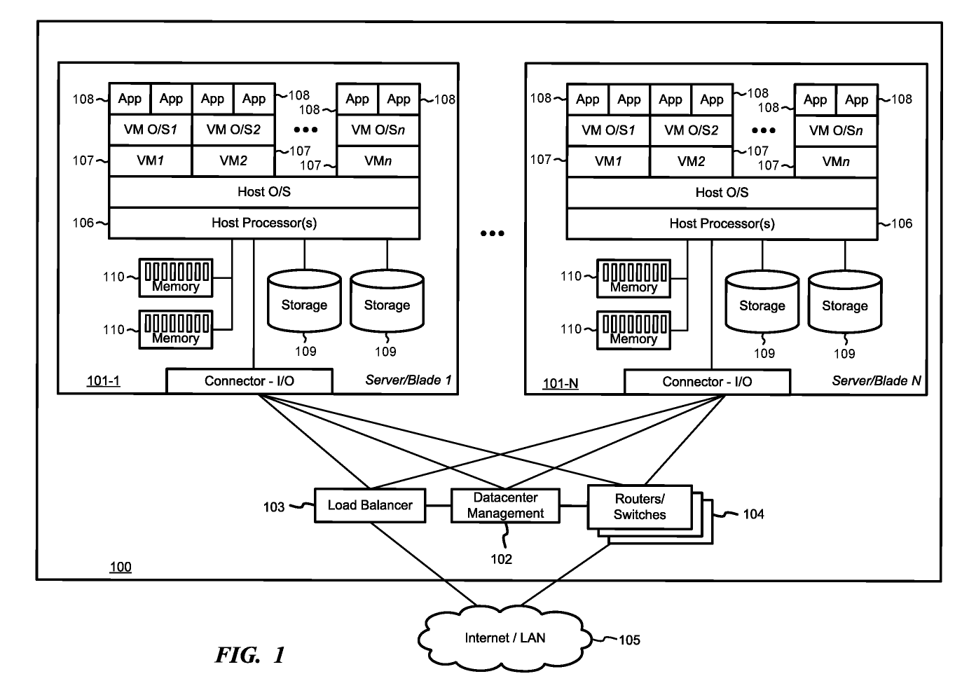

FIG. 1 is a block diagram of a distributed computing network or datacenter 100 that provides cloud computing services or distributed computing services according to one embodiment. A plurality of servers 101 are managed by datacenter management controller 102. Load balancer 103 distributes requests and workloads over servers 101 to avoid a situation where a single server 101 becomes overwhelmed and to maximize available capacity and performance of the resources in datacenter 100. Routers/switches 104 support data traffic between servers 101 and between datacenter 100 and external resources and users via external network 105, which may be a local area network (LAN) in the case of an enterprise, on-premises datacenter, or the Internet in the case of a public datacenter.

Servers 101 may be traditional standalone computing devices and/or they may be configured as individual blades in a rack of many server devices. Servers 101 have an input/output (I/O) connector that manages communication with other database entities. One or more host processors or CPUs 106 on each server 101 run a host operating system (O/S) that supports multiple virtual machines (VM) 107. Each VM 107 may run its own O/S so that each VM O/S on a server is different, or the same, or a mix of both. The VM O/S's may be, for example, different versions of the same O/S (e.g., different VMs 107 running different current and legacy versions of the Windows® operating system). In addition, or alternatively, the VM O/S's may be provided by different manufacturers (e.g., some VMs 107 running the Windows® operating system, while others VMs run the Linux® operating system). Each VM 107 may then run one or more applications (App) 108. Each server also includes storage (e.g., hard disk drives (HDD)) 109 and memory (e.g., RAM) 110 that can be accessed and used by the host processors and VMs.

Cloud computing is the delivery of computing capabilities as a service, making access to IT resources like compute power, networking, and storage as available as water from a faucet. As with any utility, you generally only pay for what you use with cloud computing. By tapping into cloud services, users can harness the power of massive data centers without having to build, manage, or maintain costly, complex IT building blocks. With the cloud, much of the complexity of IT is abstracted away, letting you focus just on the infrastructure, data and application development that really matter to your business.

Datacenter 100 provides pooled resources on which customers or tenants can dynamically provision and scale applications as needed without having to add more servers 101 or additional networking. This allows tenants to obtain the computing resources they need without having to procure, provision, and manage infrastructure on a per-application, ad-hoc basis. A cloud computing datacenter 100 allows tenants to scale up or scale down resources dynamically to meet the current needs of their business. Additionally, a datacenter operator can provide usage-based services to tenants so that they pay for only the resources they use, when they need to use them. For example, a tenant may initially use one VM 107 on server 101-1 to run their applications. When demand increases, the datacenter may activate additional VMs 107 on the same server and/or on a new server 101-N as needed. These additional VMs 107 can be deactivated if demand later drops.

Datacenter 100 may comprise hundreds or thousands of servers 101. Each server 101 has n host processors 106 wherein n is typically a multiple of two so that servers 101 may have two, four, eight, etc. host processors 106. Servers 101 may be individually configured as a blade and groups of m such blades may be mounted in a chassis. Groups of chassis may be further organized in racks, wherein each rack comprises x chassis. Racks may be further organized into clusters, which may be further organized into a plurality of availability zones, cells, and/or maintenance zones within datacenter 100.

Over time, the datacenter manager may replace and upgrade the compute and network hardware in datacenter 100 (i.e., processing units, CPUs, memory, routers, switches, etc.) as existing hardware fails or becomes obsolete or inefficient. New compute and network hardware is typically a later product generation and almost universally has improved speeds and capacities compared to hardware that was replaced. As a result of such repairs and upgrades, datacenter 100 may have varying hardware generations available over time. For example, one cluster may have racks with a first generation of servers, while at the same time a second cluster has racks with a second or later generation of servers. Over time, a datacenter that was commissioned with the first generation of hardware may be upgraded to a second or later generation of hardware. As a result, the original hardware is no longer available in the datacenter.

In typical implementation, a cloud service provider provides compute resources to tenants by selling access to the VMs 107 in datacenter 100 so that tenants can run their own applications 108. The cloud service provider of provisions each VM 107 according to the respective tenant's service agreement. The tenants expect the VMs 107 to have certain performance characteristics in terms of compute and I/O capabilities. The VMs 107 leased by the tenants have a defined set of behavioral characteristics that are dependent on the datacenter infrastructure.

Over time, as datacenter 100 is updated to newer generations of hardware, the VMs 107 for existing tenants are provisioned on the new server 101 hardware, which typically has improved performance compared to prior hardware. However, each tenant is used to and is expecting the performance characteristics and/or behavioral characteristics of the original hardware that they originally leased. Moreover, the tenant's applications 108 running on the VMs 107 may be configured to expect and to operate under the performance characteristics and/or behavioral characteristics of the original VM configuration. As datacenter 100 is updated to a newer generation of hardware, the VMs 107 running on the new server hardware 101 will have capabilities that exceed the original VM configuration for some tenants. These updates have several unintended side effects. One is providing tenants with improved services or capabilities for which they are not being charged. Another is running the tenants' applications 108 on hardware 101 with unexpected performance characteristics and/or behavioral characteristics. While upgraded equipment capabilities generally a positive event, negative results may occur if the tenants' applications 108 are not properly configured to function on the upgraded server 101 hardware. For example, if a tenant's application is moved to a VM on new hardware with a faster processor, a faster network, and more bandwidth, then the application may not operate as expected or as previously observed. If the tenant's application interacts with different applications on other servers or on other VMs and/or accesses storage 109 or memory 110, the change in the VM performance or behavior may impact how the tenant's application works with the other applications or memory.

To address these issues on the cloud provider or datacenter side, there is a need to effectively instantiate the performance characteristics and/or behavioral characteristics for the “old” or originally leased VM on the newer hardware. In embodiment, the datacenter uses tools and constraints to make the tenants' VMs behave in a similar way on newer generations of hardware,

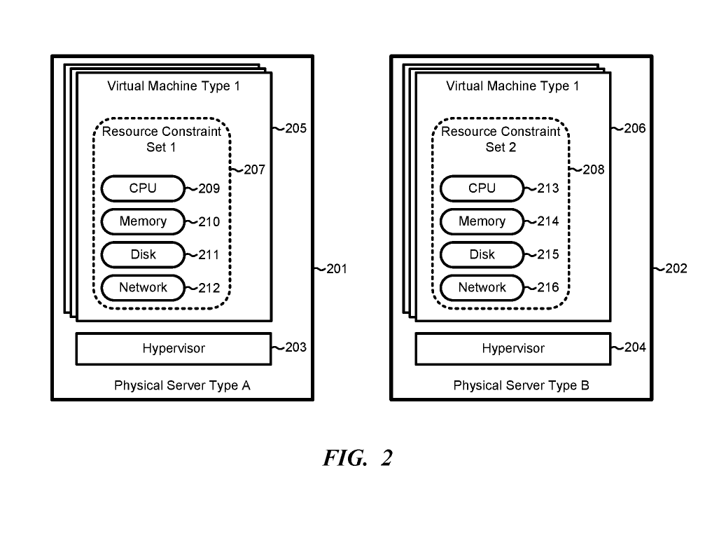

FIG. 2 is a block diagram illustrating one embodiment for shaping the behavior of VMs to keep them consistent across various hardware generations. Server 201 is of physical server type A, and server 201 is of physical server type B, which is a newer generation of server technology than type A. For example, CPUs on server type B may have faster processor speeds, larger data width, faster memory access speeds, larger internal cache, etc. Each server 201, 202 has a hypervisor 203, 204 or virtual machine monitor, which may be software or firmware that creates and runs virtual machines on a server's CPUs. Hypervisor 203, 204 provides the VMs on servers 201, 202 with a virtual operating platform and manages the execution of the VM operating systems.

Hypervisor 203 creates one or more VMs 205 on server 201 for use by a datacenter tenant, and hypervisor 204 creates one or more VMs 206 on server 202 for datacenter tenant. The tenant expects both VMs 205 and 206 to have the same performance characteristics and/or behavioral characteristics so that applications function identically on both VMs. Hypervisors 203, 204 apply a set of resource constraints 207, 208 when creating VMs 205, 206. Resource constraints 207 and 208 provide a set of tunable parameters 209-212 and 213-216 that model the tenant's VM behavior and define how the VMs 205, 206 should be adapted on each respective server type 201, 202 to provide the expected performance for the tenant. The constraints may define performance expectations for the CPU, memory, disk, network, or any other parameter that may be affected by the underlying hardware. For example, the hypervisor on the server may specify a percentage of the physical CPU or server's performance as amount that the VM should receive. That percentage may be tuned from one hardware generation to the next.

As the datacenter is updated from one hardware generation to another, the service provider can define a resource constraint set or VM model for each hardware generation. For example, resource constraint set 207 for the physical server type A 201 hardware generation may define a percentage X of the CPU resources to be used when configuring a tenant's VMs 205. In the new hardware generation for physical server type B 202, a different resource constraint set 208 sets a percentage Y for the new generation CPU resources to be used for the tenant's VMs 206 so that the new VMs 206 perform in a similar manner as VMs 205 on the previous hardware generation 201.

In addition to setting a percentage of CPU or server resources, the resource constraint sets may tune VM performance in terms of other parameters, such as tuning in terms of I/O. The disk I/O and the network I/O are available at certain rates for the VM in the first hardware generation, which may be due, for example, to the drivers on the host throttling access at that speed. In the new generation of hardware, the storage may be updated from spinning disks to flash and newer technologies that are much faster. The resource constraint sets may model the slow speed of the old technology on the new hardware by applying throttling rules for I/O on the new VM.

The resource constraint sets shape the behavior of the VMs. In addition to throttling I/O or restricting CPUs, the resource constraint sets may need to mask newer features to the VM. For example, new hardware may have new capabilities and features that were not available on the original hardware. These new capabilities and features do not have to be presented to tenants who leased an older VM model.

In FIG. 2, server 201 may represent the hardware configuration available when the tenant leased VMs, and the resource constraint set 1 207 implements no throttling or masking. When the datacenter is updated to hardware 202, resource constraint set 2 208 implements throttling and/or masking as required so that VM 206 operates in the same manner as VM 205. Alternatively, the tenant may have originally leased VMs on earlier hardware configuration, and servers 201 and 202 may represent the mix of hardware that is currently available in the datacenter. In this situation, resource constraint set 1 207 implements throttling and/or masking on server type A 201 and resource constraint set 2 208 implements a different type of throttling and/or masking on server type B 202 so that both sets of VMs 205, 206 function in a similar manner.

Benchmarks, such as evaluations of speed, latency, throughput, I/O patterns, etc., can be run on different hardware generations to determine what constrains or throttling would be required to ensure similar VM performance across different hardware. For example, a VM may be started up on a new physical machine on a 40-gigabyte network, but the VM was moved from an older 1 gigabyte network to the new hardware, so the datacenter can preserve the expected functionality by throttling the VM on the new hardware. The resource constraint sets are generated by modeling the VM that the tenant purchased to identify what parameters are needed and should be constrained or throttled in some way. Once the model is created, the parameters constraints or throttling is enforced by the hypervisor or virtual machine manager in the virtualization stack on the host machine. The hypervisor may employ custom device drivers, for example, to model an “old” VM on new hardware.

By throttling VMs created on new server hardware, the server capacity is not used up as fast as it would be by unrestricted VMs—i.e., more throttled VMs may be supported by the new server than the expected number of unrestricted VMs. As a result, a higher density of VMs may be run on the new server, which is more efficient and cost effective for the datacenter service provider.

When a tenant signs up for (e.g., leases, purchases, rents) a VM on a cloud service, the tenant gets a particular VM type, which may be defined by a model. The mapping between the VM type and the model is stored with cloud service provider. For example, the tenant may be offered several generic types of VM that are supported by the current datacenter hardware and that will be allowed to move to later hardware generations. The tenant may elect to pin the VM to a particular hardware generation so that the VM capabilities are known and when that hardware changes, the VMs will no longer be running. Alternatively, using the VM modeling described herein, the VMs are moveable to new hardware, but they maintain known characteristics and behaviors. This gives the tenants more choices. The tenants can pick a generic VM that can be moved around to different hardware and still preserve expected behavior. The tenants may or may not be aware of the changes in underlying hardware. In one embodiment, the hardware updates and VM movement is transparent to the tenant and their applications continue to operate as usual during upgrades.

By modeling VM resources and specifying VM resource constraints, the datacenter service provider can enforce the model and constraints to ensure that a specific VM will perform in a consistent manner across different hardware. The constraints on virtual resources can be specified as either absolute limits or as a percentage of the physical resource. A VM can be modeled with a different set of constraints on different physical hardware to achieve consistent performance. This provides the cloud service with the ability to sell, support, and deploy the same VM and associated performance characteristics on different and/or evolving physical hardware.

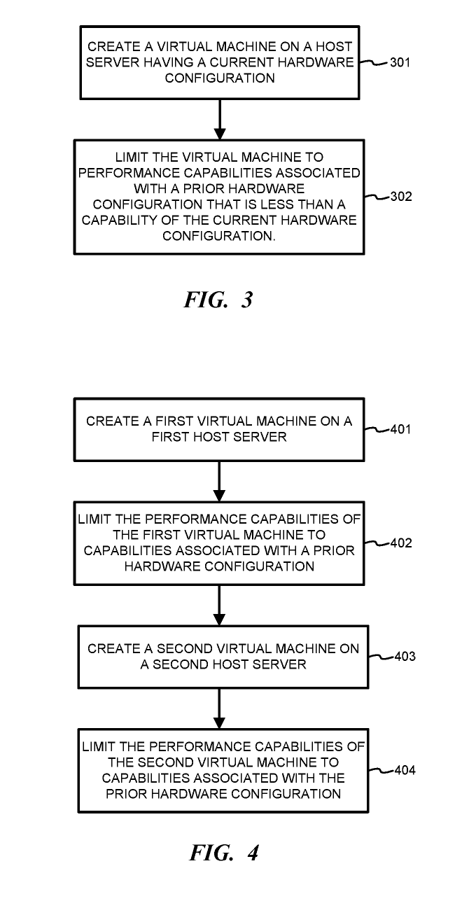

FIG. 3 illustrates a computer-implemented method for configuring virtual machines according to one embodiment. In step 301, a virtual machine is created on a host server having a current hardware configuration. In step 302, the virtual machine is limited to performance capabilities that are associated with a prior hardware configuration that is less than or equal to a capability of the current hardware configuration. The performance capabilities may be defined by a set of resource constraints that limit functionality of the virtual machine to a level that is less than or equal to a capability of the current hardware configuration.

The performance capabilities may be defined as absolute limitations virtual machine resources. The performance capabilities may be defined as a fraction of a physical resource on the host server. The performance capabilities may be defined by a behavior profile for one or more virtual machine resources.

FIG. 4 illustrates a computer-implemented method for configuring virtual machines according to another embodiment. In step 401, a first virtual machine is created on a first host server. In step 402, the performance capabilities of the first virtual machine are limited to capabilities associated with a prior hardware configuration.

In step 403, a second virtual machine is created on a second host server. In step 404, the performance capabilities of the second virtual machine are limited to capabilities associated with the prior hardware configuration.

The first host server may have a first hardware type, and the second host server may have a second hardware type, wherein the first hardware type and the second hardware type are different from the prior hardware configuration. The first hardware type and the second hardware type may be different hardware generations operating simultaneously in a distributed computer network.

In an example embodiment, a distributed computer network comprises: a plurality of servers, each server hosting one or more virtual machines, wherein at least one virtual machine is configured with a set of resource constraints that limit functionality of the at least one virtual machine to a level that is less than or equal to a capability of physical hardware of the server running the virtual machine.

The distributed computer network may further comprise a tenant application executing on the at least one virtual machine, wherein the tenant application is configured for the functionality defined by the set of resource constraints.

The set of resource constraints in the distributed computer network may define absolute limitations for one or more virtual machine resources.

The set of resource constraints in the distributed computer network may define a fraction of a physical resource that is available to the at least one virtual machine.

The set of resource constraints in the distributed computer network may define a behavior profile for the at least one virtual machine resources.

The distributed computer network may further comprise: a first virtual machine hosted on a first server having a first hardware type, the first virtual machine configured with a first set of resource constraints; and a second virtual machine hosted on a second server having a second hardware type, the second virtual machine configured with a second set of resource constraints; wherein the first hardware type and the second hardware type are different, and wherein the first and second sets of resource constraints cause the first and second virtual machines to achieve a consistent performance on both machines.

The first hardware type and the second hardware type in the distributed computer network may be different hardware generations operating simultaneously in the distributed computer network.

The first hardware type in the distributed computer network may be a first hardware generation and the second hardware type is a second hardware generation that is replacing the first hardware generation, and wherein a tenant's applications are migrated from the first virtual machine to the second virtual machine.

In an example embodiment, a computer-implemented method comprises: creating a virtual machine on a host server having a current hardware configuration; and limiting the virtual machine to performance capabilities associated with a prior hardware configuration that is less than or equal to a capability of the current hardware configuration.

The performance capabilities in the computer-implemented method may be defined by a set of resource constraints that limit functionality of the virtual machine to a level that is less than or equal to a capability of the current hardware configuration.

The performance capabilities in the computer-implemented method may be defined as absolute limitations virtual machine resources.

The performance capabilities in the computer-implemented method may be defined as a fraction of a physical resource on the host server.

The performance capabilities in the computer-implemented method may be defined by a behavior profile for one or more virtual machine resources.

The computer-implemented method may further comprise: creating a first virtual machine on a first host server; and creating a second virtual machine on a second host server; wherein the first and second virtual machine are limited to the performance capabilities associated with the prior hardware configuration.

The first host server in the computer-implemented method may have a first hardware type, and the second host server may have a second hardware type; wherein the first hardware type and the second hardware type are different from the prior hardware configuration.

The first hardware type and the second hardware type in the computer-implemented method may be different hardware generations operating simultaneously in a distributed computer network.

In an example embodiment, a server, comprises: a virtual machine manager configured to manage one or more virtual machines on the server; at least one virtual machine hosted on the server, the at least one virtual machine configured by the virtual machine manager using a set of resource constraints that limit functionality of the at least one virtual machine to a level that is less than or equal to a capability of physical hardware of the server.

The set of resource constraints in the server may define absolute limitations for one or more virtual machine resources based upon capabilities of a different physical server.

The set of resource constraints in the server may define a fraction of a physical resource that is available to the at least one virtual machine based upon capabilities of a different physical server.

The set of resource constraints in the server may define a behavior profile for the at least one virtual machine resources based upon capabilities of a different physical server.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A distributed computer network, comprising:
a plurality of servers, each server hosting one or more virtual machines, wherein at least one virtual machine is configured with a set of resource constraints that limit functionality of the at least one virtual machine to a level that is less than or equal to a capability of physical hardware of the server running the virtual machine.

2. The distributed computer network of claim 1, further comprising:
a tenant application executing on the at least one virtual machine, wherein the tenant application is configured for the functionality defined by the set of resource constraints.

3. The distributed computer network of claim 1, wherein the set of resource constraints defines absolute limitations for one or more virtual machine resources.

4. The distributed computer network of claim 1, wherein the set of resource constraints defines a fraction of a physical resource that is available to the at least one virtual machine.

5. The distributed computer network of claim 1, wherein the set of resource constraints defines a behavior profile for the at least one virtual machine resources.

6. The distributed computer network of claim 1, further comprising:
a first virtual machine hosted on a first server having a first hardware type, the first virtual machine configured with a first set of resource constraints; and
a second virtual machine hosted on a second server having a second hardware type, the second virtual machine configured with a second set of resource constraints;
wherein the first hardware type and the second hardware type are different, and wherein the first and second sets of resource constraints cause the first and second virtual machines to achieve a consistent performance on both machines.

7. The distributed computer network of claim 6, wherein the first hardware type and the second hardware type are different hardware generations operating simultaneously in the distributed computer network.

8. The distributed computer network of claim 6, wherein the first hardware type is a first hardware generation and the second hardware type is a second hardware generation that is replacing the first hardware generation, and wherein a tenant's applications are migrated from the first virtual machine to the second virtual machine.

9. A computer-implemented method, comprising:
creating a virtual machine on a host server having a current hardware configuration; and
limiting the virtual machine to performance capabilities associated with a prior hardware configuration that is less than or equal to a capability of the current hardware configuration.

10. The computer-implemented method of claim 9, wherein the performance capabilities are defined by a set of resource constraints that limit functionality of the virtual machine to a level that is less than or equal to a capability of the current hardware configuration.

11. The computer-implemented method of claim 9, wherein the performance capabilities are defined as absolute limitations virtual machine resources.

12. The computer-implemented method of claim 9, wherein the performance capabilities are defined as a fraction of a physical resource on the host server.

13. The computer-implemented method of claim 9, wherein the performance capabilities are defined by a behavior profile for one or more virtual machine resources.

14. The computer-implemented method of claim 9, further comprising:
creating a first virtual machine on a first host server; and
creating a second virtual machine on a second host server;
wherein the first and second virtual machine are limited to the performance capabilities associated with the prior hardware configuration.

15. The computer-implemented method of claim 14, wherein the first host server has a first hardware type, and the second host server has a second hardware type; and wherein the first hardware type and the second hardware type are different from the prior hardware configuration.

16. The computer-implemented method of claim 15, wherein the first hardware type and the second hardware type are different hardware generations operating simultaneously in a distributed computer network.

17. A server, comprising:
a virtual machine manager configured to manage one or more virtual machines on the server;
at least one virtual machine hosted on the server, the at least one virtual machine configured by the virtual machine manager using a set of resource constraints that limit functionality of the at least one virtual machine to a level that is less than or equal to a capability of physical hardware of the server.

18. The server of claim 17, wherein the set of resource constraints defines absolute limitations for one or more virtual machine resources based upon capabilities of a different physical server.

19. The server of claim 17, wherein the set of resource constraints defines a fraction of a physical resource that is available to the at least one virtual machine based upon capabilities of a different physical server.

20. The server of claim 17, wherein the set of resource constraints defines a behavior profile for the at least one virtual machine resources based upon capabilities of a different physical server.
